(19) United States
(12) Patent Application Publication
(10) Pub. No.: US 2023/0184146 A1
(43) Pub. Date: Jun. 15, 2023

(54) A MUFFLER HEAT-EXCHANGER FOR AN ENGINE EXHAUST, AND ENGINE EXHAUST SYSTEM, AND AN ENGINE SYSTEM

(71) Applicant: Oxford University Innovation Limited, Oxford (Osfordshire) (GB)

(72) Inventors: Kam CHANA, Oxford (Oxfordshire) (GB); Vikram SRIDHAR, Oxford (Oxfordshire) (GB); Craig MEAD, Godalming (Surrey) (GB)

(21) Appl. No.: 17/925,862

(22) PCT Filed: May 19, 2021
(86) PCT No.: PCT/GB2021/051202

§ 371 Date: Nov. 17, 2022

(30) Foreign Application Priority Data
May 19, 2020 (GB) 2007403.5

(51) Int. Cl. F01N 1/02; F01N 5/02; F02B 39/10

(52) U.S. Cl. CPC F01N 1/02; F01N 5/025; F02B 39/10; F01N 2230/00

(57) ABSTRACT

The present application provides a muffler-heat exchanger (15) for an engine exhaust. The muffler-heat exchanger comprises a chamber (16) having an inlet (17) and an outlet (18) arranged such that during use exhaust gases flow through from the inlet to the outlet through the chamber. The muffler-heat exchanger also has at least one heat exchange baffle (25) disposed in the chamber to recover heat energy from the exhaust gases during use. The at least one heat exchange baffle is configured to reflect acoustic waves in the exhaust gases towards the inlet to generate destructive interference and impede incoming acoustic waves at the inlet. The present application also provides an exhaust system and an engine system.

This invention relates to a combined muffler-heat exchanger for an engine exhaust. This invention also relates to an engine exhaust system, and an engine system.

### BACKGROUND

Turbochargers are provided on internal combustion engines to increase power and efficiency. A turbocharger has a turbine that is rotated by exhaust gases from the internal combustion engine, and the turbine is coupled to a compressor that compresses air at the air inlet of the internal combustion engine. In this way, additional power is provided when the internal combustion engine runs at higher speeds.

Mufflers are installed within the exhaust system of internal combustion engines. The muffler is an acoustic device that reduces the loudness of the sound pressure created by the engine. In some mufflers the noise of the exhaust gas exiting the engine at high speed is abated by a series of passages and chambers lined with fiberglass insulation to absorb energy. Other mufflers have resonating chambers harmonically tuned to cause destructive interference in the acoustic waves.

### BRIEF SUMMARY OF THE DISCLOSURE

In accordance with the present disclosure there is provided a muffler heat-exchanger for an engine exhaust. The muffler heat-exchanger comprises a chamber having an inlet and an outlet arranged such that during use exhaust gases flow from the inlet to the outlet through the chamber. The muffler heat-exchanger includes a heat exchanger arranged to extract thermal energy from the exhaust gases in the chamber. The muffler heat-exchanger also includes a muffler arranged to impede acoustic waves in the exhaust gases in the chamber.

Recovered thermal energy may be conveyed away from the chamber for use, for example to generate electrical power.

The combination of a muffler and a heat exchanger provides for recovering thermal energy from the exhaust gases while muffling the sound of the engine exhaust by impeding acoustic waves.

The muffler may be one or more of a reactive muffler, an interference muffler, and/or a labyrinth (lagged or unlagged) muffler. The heat exchange preferably includes heat exchange baffles that extend into or through the chamber. The heat exchange baffles preferably comprise a heat exchange fluid channel for a heat exchange fluid that extracts thermal energy from the exhaust gases.

Advantageously, reducing the temperature of the exhaust gases by providing the heat exchanger also increases the density of the exhaust gases, decreases the velocity of the exhaust gases, and shortens the wavelength of the acoustic waves. Advantageously, this means that the muffler can be smaller (e.g. smaller diameter tubes). In addition, the shortened wavelength means that any resonance chambers can be smaller. Accordingly, the exhaust system, in particular the muffler, can be smaller and more compact.

In preferred examples, the muffler heat-exchanger comprises:

a chamber having an inlet and an outlet arranged such that during use exhaust gases flow through from the inlet to the outlet through the chamber, and

at least one heat exchange baffle disposed in the chamber to recover heat energy from the exhaust gases during use,

wherein the at least one heat exchange baffle is configured to reflect acoustic waves in the exhaust gases towards the inlet to generate destructive interference and impede incoming acoustic waves at the inlet.

In some examples, the at least one heat exchange baffle is elongate and an end of the elongate heat exchange baffle is directed towards the inlet to reflect acoustic waves in the exhaust gases.

Preferably, an end of the at least one heat exchange baffle is spaced from the inlet by a distance of about quarter of a wavelength of an acoustic wave in the exhaust gases. The muffler-heat exchanger may be configured to muffle acoustic waves having a wavelength between about 0.015 m and about 40 m.

Preferably, the chamber comprises an inlet sub-chamber disposed between the inlet and the end of the at least one heat exchange baffle, and wherein the inlet sub-chamber is configured to act as a resonance chamber for acoustic waves of the exhaust gases.

In preferred examples, the muffler heat-exchanger comprises a plurality of heat exchange baffles. The plurality of heat exchange baffles may be arranged parallel to each other. The plurality of heat exchange baffles may be spaced apart to define channels between adjacent heat exchange baffles. Adjacent heat exchange baffles are preferably spaced apart by between about 3 millimetres and about 8 millimetres.

The at least one heat exchange baffle preferably comprises a heat exchange fluid channel for a heat exchange fluid. Preferably, the at least one heat exchange baffle comprises a planar section defining a side of at least one channel. The planar section is preferably hollow defining a cavity therein. In preferred examples the heat exchange fluid channel comprises the cavity. In other examples, the heat exchange fluid channel may be a tube that extends through the heat exchange baffle, for example through a hollow cavity within the heat exchange baffle. In other examples, the heat exchange fluid channel is integral with the heat exchange baffle.

In some examples the at least one heat exchange fluid channel is connected to a heat exchange fluid circuit arranged to circulate the heat exchange fluid to an electrical power generator.

In some examples, the muffler heat-exchanger may further comprise a second muffler configured to impede acoustic waves in the exhaust gases. Preferably, the second muffler is arranged downstream of the at least one heat exchange baffle. In particular, the second muffler may be arranged either at a downstream end of the chamber, or downstream of the outlet. Advantageously, the second muffler can be smaller and more compact because the temperature of the exhaust gases has been reduced by the at least one heat exchange baffle before reaching the second muffler.

According to a further aspect of the present invention, there is also provided an exhaust system comprising the muffler heat-exchanger described above.

According to a further aspect of the present invention, there is also provided an engine system comprising an internal combustion engine, the exhaust system described above, and an electrical power generator. The exhaust system is arranged to receive exhaust gases from the internal combustion engine, and the electrical power generator is configured to generate electrical power from the thermal energy recovered by the muffler heat-exchanger.

Preferably, the engine system further comprises a heat exchange fluid circuit configured to circulate a heat exchange fluid between the muffler heat-exchanger and the electrical power generator.

In examples, the internal combustion engine comprises an air inlet, and the engine system further comprises an electrically-driven compressor arranged to compress air for the air inlet.

The engine system may further comprise a power management system arranged to manage electrical power generated by the electrical power generator, and to supply electrical power to the electrically-driven compressor.

In an alternative example, a combined muffler heat-exchanger for an exhaust system includes a chamber, an inlet and an outlet. Exhaust gases flow through the inlet, chamber, and outlet during use. A porous heat-conducting material is disposed within the chamber and at least partially fills the chamber. In some examples, the porous heat-conducting material fills a cross-section of the chamber so that the exhaust gases have to pass through the porous heat-conducting material between the inlet and the outlet. In other examples, the porous heat-conducting material is arranged on one or more sides of the chamber, and an unobstructed path is provided through the chamber. The porous heat-conducting material permits exhaust gases to flow through it while impeding acoustic waves in the exhaust gases. The muffler heat-exchanger also includes a heat exchange fluid channel that is at least partially surrounded by the porous heat-conducting material. In this way, thermal energy is transferred from the exhaust gases to heat exchange fluid in the heat exchange fluid channel via the porous material during use, while the porous heat-conducting material acts to impede acoustic waves in the exhaust gases.

In some examples, the chamber comprises one or more heat-exchange baffles arranged to divert the flow of exhaust gases along a non-linear path between the inlet and the outlet. One or more heat-exchange baffles may be arranged to define a meandering conduit for flow of exhaust gases between the inlet and the outlet. At least a portion of the meandering conduit may be provided with the porous heat-conducting material. In particular, the heat-exchange baffles may be at least partially covered by the porous heat-conducting material. In other examples, the porous heat-conducting material fills an entire cross-section of the meandering conduit in at least one location. At least some of the heat-exchange baffles may comprise a heat exchange fluid channel for circulation of heat exchange fluid. During use, thermal energy is transferred from the exhaust gases to the heat exchange fluid via the porous heat-conducting material.

In other examples, the heat exchange baffles may extend to outside of the chamber to transfer heat. A heat exchanger and/or electrical power generator may be provided outside of the chamber to receive thermal energy from the heat exchange baffles.

In examples, an inlet sub-chamber may be defined between the inlet and the porous heat-conducting material and/or the first heat exchange baffle. Such an inlet sub-chamber may be configured to reflect acoustic waves back towards the inlet to generate destructive interference of incoming acoustic waves at the inlet. Similarly, an outlet sub-chamber may be provided between the outlet and the porous heat-conducting material and/or the last heat-exchange baffle.

The porous heat conducting material may be made of, for example, a porous metal foam or a porous metal matrix material. An example of a porous metal foam is Dunlop Retimet®. A porous metal matrix may be manufacturing using additive manufacturing.

In other examples, a combined muffler heat-exchanger is an interference muffler with integrated heat exchange fluid channels. In particular, the interference muffler heat-exchanger comprises a first conduit and a second conduit. The first conduit and the second conduit divide at a first junction and merge at a second junction. The length of the first conduit between the first and second junctions is different to the length of the second conduit between the first and second junctions. Exhaust gases, and acoustic waves, pass through both the first and second conduits and so at the second junction acoustic waves in the second conduit are at a different phase to acoustic waves in the first conduit, and destructive interference acts to impede acoustic waves in the re-combined exhaust gases. The first and/or second conduits include a heat exchange fluid channels arranged to extract thermal energy from the exhaust gases.

In different examples, the heat exchange fluid channel may extend along a side wall of the first and/or second conduit. Alternatively, a heat exchange fluid channel may extend transversely across the first and/or second conduit. In other examples, a heat exchange fluid channel may extend in the longitudinal direction of the first and/or second conduit. The heat exchange fluid channel may comprise a tube or a hollow baffle through which heat exchange fluid flows.

As with previous examples, a porous heat-conducting material, for example a porous metal foam or a porous metal matrix, may be provided within the conduits and at least partially covering the heat exchange fluid channels. The porous heat-conducting material acts to impede acoustic waves in the exhaust gases and also improves conduction of thermal energy from the exhaust gases to the heat exchange fluid channel.

The interference muffler heat-exchanger may comprise more than two branched conduits. For example, the interference muffler heat-exchanger may comprise third and fourth conduits branching from either the first or second conduits and having different lengths. The conduits may divide and merge such that the conduits are connected in series or in parallel. The conduits may be connected in groups.

According to some aspects of the present invention, there is also disclosed an exhaust system that includes one or more of the muffler heat-exchangers described above. The engine system may include a reactive muffler heat-exchanger, an interference muffler heat-exchanger, and/or a labyrinth (lagged or unlagged) muffler heat-exchanger.

In some examples, a labyrinth muffler heat-exchanger is combined with a reactive muffler heat-exchanger and/or an interference muffler heat-exchanger. In other examples, a reactive muffler heat-exchanger is combined with an interference muffler heat-exchanger. Different muffler heat-exchangers may be configured to impede different wavelength acoustic waves in the exhaust gases.

According to some aspects of the present invention, there is also disclosed an engine system that includes an internal combustion engine, the exhaust system described above, the exhaust system being arranged to receive exhaust gases from the internal combustion engine, and an electrical power generator configured to generate electrical power from the thermal energy recovered by the muffler heat-exchanger.

Such an engine system may be used in an automotive application, for example as a primary driver of a vehicle such as a car, van, or heavy good vehicle. Alternatively, the engine system may be used as an auxiliary system, for example to generate electrical power for a refrigeration system. In other examples, the engine system may be used in a marine application, for example to power a propeller or impeller of a marine vessel, or to generate electrical power for use onboard the marine vessel. In other examples, the engine system may be a power generator, for example at a residence, commercial, or industrial building.

In preferred examples the engine system also comprises a heat exchange fluid circuit configured to circulate a heat exchange fluid between the muffler heat-exchanger and the electrical power generator.

The internal combustion engine may comprise an air inlet. The engine system may further comprise an electrically-driven compressor arranged to compress air for the air inlet. In this example, the engine system may further comprise a power management system arranged to manage electrical power generated by the electrical power generator, and to supply electrical power to the electrically-driven compressor.

Advantageously, the air compressor can be operated to increase inlet air pressure, and therefore increase the power and efficiency of the internal combustion, engine, regardless of the current operating speed of the internal combustion engine (in particular exhaust flow and pressure). Therefore, the air compressor can be operated in circumstances that a conventional turbocharger is not able to.

The present disclosure also provides an exhaust system for an internal combustion engine. The exhaust system has a heat exchange portion and a muffler portion arranged such that exhaust gases flow through the heat exchange portion and the muffler portion. The heat exchange portion is configured to extract thermal energy from the exhaust gases, and the muffler portion is configured to impede acoustic waves in the exhaust gases. In preferred examples, the heat exchange portion is arranged upstream of the muffler portion, or is aligned with at least an upstream end of the muffler portion.

In particular, in some examples the heat exchange portion and the muffler portion are separate and the heat exchange portion is arranged upstream of the muffler portion. In other examples, the exhaust system includes a combined muffler heat-exchanger, as previously described. In these examples, the heat exchange portion (i.e. components that extract thermal energy from the exhaust gases) may be arranged upstream of the muffler portion (i.e. components that impede acoustic waves in the exhaust gases). In various examples, the heat exchange portion and the muffler portion may overlap, and the heat exchange portion is provided at least at the inlet of the muffler portion, and preferably upstream of the muffler portion. For example, the exhaust system may have an inlet and an outlet, and the muffler portion may extend from the inlet to the outlet. The heat exchange portion may extend from the inlet to an intermediate point of the exhaust system.

In such examples, the heat exchange portion acts to extract thermal energy from the exhaust gases as soon as they enter the exhaust system. Therefore, the temperature of the exhaust gases is lowered, which increases the density of the exhaust gases, decreases the velocity of the exhaust gases, and shortens the wavelength of the acoustic waves. Advantageously, this means that the muffler portion can be smaller (e.g. smaller diameter tubes). In addition, the shortened wavelength means that resonance chambers can be smaller. Accordingly, the exhaust system, in particular the muffler portion, can be smaller and more compact.

### BRIEF DESCRIPTION OF THE DRAWINGS

Embodiments of the invention are further described hereinafter with reference to the accompanying drawings, in which:

FIG. 1 is a schematic diagram of an engine system;

FIGS. 2A to 2C are schematic diagrams of example combined reactive muffler heat-exchangers;

FIG. 3 illustrates the heat exchange baffles of the reactive muffler heat-exchangers of FIGS. 2A and 2B;

FIG. 4 is a schematic diagram of a combined labyrinth muffler heat-exchanger;

FIG. 5 is a schematic diagram of an alternative combined labyrinth muffler heat-exchanger;

FIGS. 6A, 6B, and 6C illustrate different heat exchange materials for use in the combined labyrinth muffler heat-exchangers of FIGS. 4 and 5;

FIG. 7 is a schematic diagram of a combined lagged muffler heat-exchanger;

FIGS. 8A and 8B are schematic diagrams of combined interference muffler heat-exchangers;

FIGS. 9A and 9B illustrate heat exchange fluid channels of the combined interference muffler heat-exchangers of FIGS. 8A and 8B; and

FIGS. 10A to 10C illustrate different arrangements of the heat exchange portion and the muffler portion of combined muffler heat-exchangers.

### DETAILED DESCRIPTION

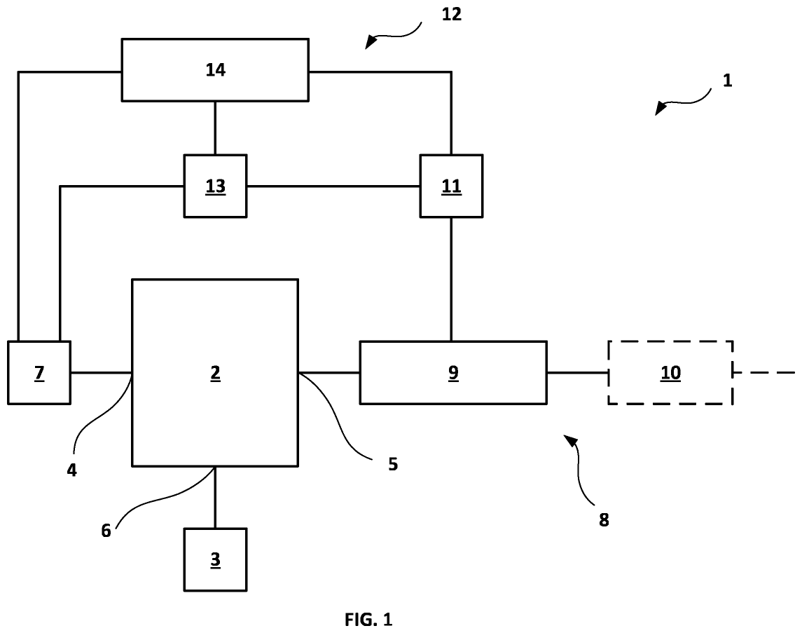

FIG. 1 shows an engine system 1 including an internal combustion engine 2. The engine system 1 is configured to generate power for a functional unit 3, as described below.

In some examples the engine system 1 may be used in an automotive application, for example in a car, particularly a hybrid car, or in a commercial vehicle such as a van or truck. As will become apparent hereinafter, the engine system 1 may directly drive the vehicle, or may generate electricity for powering electric motors that drive the vehicle. The engine system 1 may be part of a range extender system.

In other examples, the engine system 1 may be part of an auxiliary vehicle system, for example it may be used to drive a generator that powers a refrigeration system of a refrigerated commercial vehicle.

In other examples, the engine system 1 may be used in a marine application, for example for driving a propulsion system of a marine vessel (e.g. a propeller or impeller), or for generating electrical power for powering a propulsion system and/or auxiliary systems of the marine vessel.

In some examples, the engine system 1 may be used in a power generation system, where the internal combustion engine 2 is arranged to drive an electrical generator. Such a power generation system may, for example, be used to generate power for a vehicle, building or industrial equipment.

Accordingly, the functional unit 3 of the engine system is appropriate for the application of the engine system 1. In some examples, the functional unit 3 may be a drive system, such as a gearbox and wheels or propeller. In other examples the functional unit 3 may be an electrical power generator that is rotated by the internal combustion engine 2.

The internal combustion engine 2 has an air inlet 4 and an exhaust outlet 5. As described above, the internal combustion engine 2 includes an output 6 to a functional unit 3. The output 6 may comprise an output shaft. Other features and components of the internal combustion engine 2, for example a fuel supply, are not illustrated.

The engine system 1 also comprises an air compressor 7 arranged to compress air for the air inlet 4 of the internal combustion engine 2. The air compressor 7 is electrically-driven. Providing the air compressor 7 increases the power and efficiency of the internal combustion engine 2.

An exhaust system 8 is arranged to receive the exhaust gases of the internal combustion engine 2 at the exhaust outlet 5.

As illustrated, in this example the exhaust system 8 includes an energy recovery system 9 and a muffler 10. The energy recovery system 9 is configured to extract heat from the exhaust gases, and the muffler 10 is configured to impede acoustic waves in the exhaust gases to reduce the noise of the engine system 1.

In preferred examples the energy recovery system 9 is a heat exchanger. As described further hereinafter, in preferred examples the heat exchanger 9 and the muffler 10 are combined. In other examples, the energy recovery system 9 and the muffler 10 are separate, as illustrated in FIG. 1.

Combining the heat exchanger 9 and the muffler 10 into a combined muffler heat-exchanger has advantages for packaging (i.e. how the heat exchanger 9 and muffler 10 are integrated into a vehicle or other system), weight, efficiency and acoustic wave impedance. In particular, removing thermal energy from the exhaust gases causes the density of the exhaust gases to increase and the wavelength of acoustic waves in the exhaust gases to shorten. Advantageously, this means that a smaller muffler can be used to provide the desired acoustic impedance. As explained further hereinafter, the heat exchanger 9 is arranged upstream of, or in line with, the muffler 10 so that thermal energy is removed from the exhaust gases upstream of the muffler 10, or at least from the inlet of the muffler 10.

As illustrated, the energy recovery system 9 conveys the thermal energy to an electrical power generator 11 that converts thermal energy into electrical power. As explained in detail hereinafter, in some examples a heat exchange fluid is circulated between the heat exchanger 9 and the electrical power generator 11 to convey the thermal energy.

In various examples, the electrical power generator 11 may include an engine that operates on a Rankine cycle to rotate a generator, a heat engine that is arranged to rotate a generator, or a thermoelectric generator that relies on the Seebeck effect to produce electrical energy (e.g. an automotive thermoelectric generator). Other systems for converting thermal energy into electrical energy are also possible.

The electrical power generator 11 outputs electrical power to a power control circuit 12 that optionally includes a battery 13. The power control circuit 12 includes a power controller 14 that is configured to control the air compressor 7 using electrical power from the electrical power generator 11 and/or the battery 13. In some examples the power control circuit 12 does not have a battery 13, and electrical power is used to directly power the air compressor 7 and/or other systems.

Advantageously, such an engine system 1 provides for recovering thermal energy that would otherwise go to waste. Furthermore, using that recovered energy to power the air compressor 7 results in increased efficiency and power of the internal combustion engine 2. Moreover, the arrangement disclosed above, in which the air compressor 7 is electrically powered by the power control circuit 12, means that operation of the air compressor 7 is not linked to the rotational speed of the internal combustion engine 2, as is usual with a conventional turbocharger arrangement. Therefore, the air compressor 7 can be operated at the optimal power and speed according to the operating conditions of the engine system 1. For example, the air compressor can be operated when an automotive engine requires increased power (i.e. when accelerating), and switched off when increased power is not required (i.e. when cruising). Conventional turbochargers deal with this by venting exhaust gases when increased power is not required, and the decoupling of the exhaust gases from the air compressor avoids the need for this and improves efficiency of the system further as no energy is wasted by venting. Moreover, electrical power generated from the recovered thermal energy can be used for other electrically powered components of the engine system 1 or the wider application, for example elsewhere in the vehicle.

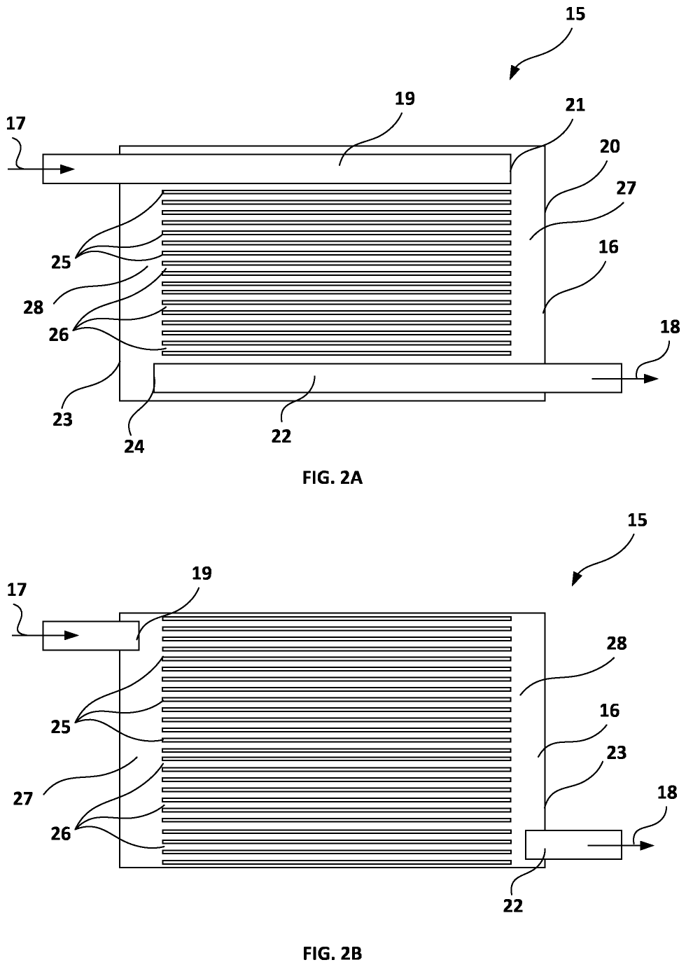

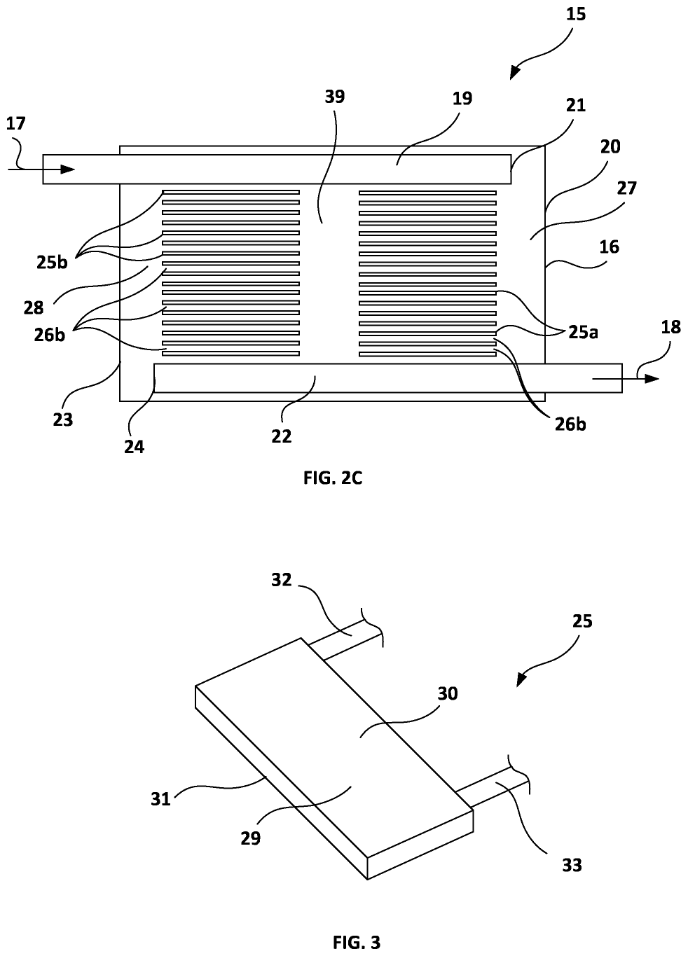

As described above, the exhaust system 1 preferably includes a combined muffler energy recovery system, in particular a combined muffler heat-exchanger. FIGS. 2A to 9B illustrate different examples of a combined muffler heat-exchanger 15 for use in the engine system 1 of FIG. 1. As described above, the combined muffler heat-exchanger is provided in an exhaust system 8 of an engine system 1 and acts to remove thermal energy from the exhaust gases while also impeding acoustic waves in the exhaust system 8.

FIG. 2A to 2C schematically illustrate combined reactive muffler heat-exchangers 15 that are formed of a reactive muffler with an integrated heat exchanger. As illustrated in FIGS. 2A to 2C, the reactive muffler heat-exchangers comprise a chamber 16 having an inlet 17 and an outlet 18 that are fluidly connected via the chamber 16. The inlet 17 and the outlet 18 are preferably offset from each other.

In the example of FIGS. 2A and 2C the inlet 17 comprises an inlet tube 19 extending into the chamber 16. Preferably, the inlet tube 19 extends to an opposite side 20 of the chamber 16 such that an end 21 of the inlet tube 19 is proximal to, and spaced from, the opposite side of the chamber 20. Similarly, the outlet 18 comprises an outlet tube 22 extending into the chamber 16. Preferably, the outlet tube 22 extends to an opposite side 23 of the chamber 16 such that an end 24 of the outlet tube 22 is proximal to, and spaced from, the opposite side 23 of the chamber 16. The sides 20, 23 of the chamber 16 are opposite to each other.

In the example of FIG. 2B the inlet tube 17 and the outlet tube 18 extend only a small amount into the chamber 16.

In other examples, the inlet 17 and the outlet 18 do not comprise an inlet tube and outlet tube, respectively, and instead the inlet 17 and the outlet 18 are formed in the opposing sides 20, 23 of the chamber 16.

As illustrated, the reactive muffler heat-exchangers 15 of FIGS. 2A to 2C comprise a plurality of heat exchange baffles 25. The heat exchange baffles 25 form a part of a heat exchanger and also act to impeded acoustic waves in the exhaust gases, as described below.

The heat exchange baffles 25 are arranged parallel to each other and define channels 26 in between the heat exchange baffles 25. The exhaust gases flow from the inlet 17 to the outlet 18 through the channels 26 between the heat exchange baffles 25.

In the illustrated examples the reactive muffler heat-exchangers 15 include a plurality of heat exchange baffles 25 defining a plurality of channels 26. However, it will be appreciated that in some alternative examples the reactive muffler heat-exchanger 15 may comprise one heat exchange baffle 25 defining one or two channels 26 through the chamber 16, or any number of heat exchange baffles defining a corresponding number of channels 26.

Preferably, the width of the channels 26 (i.e. the size of the gaps between adjacent heat exchange baffles 25) is preferably between about 3 millimetres and about 8 millimetres. Such a channel size provides effective heat transfer and acoustic impedance due to the viscosity between the exhaust gases and the heat exchange baffles 25 in the channels 26. The viscosity also increases heat transfer from the exhaust gases to the heat exchange baffles. In addition, the arrangement of the ends of the heat exchange baffles 25 provides an effective surface that will reflect acoustic waves in the exhaust gases.

In examples, the width of each of the heat exchange baffles 25 is preferably between about 3 millimetres and about 8 millimetres.

In some examples, a porous conductive material is disposed in the channels 26 between the heat exchange baffles 25. For example, a metal matrix or metal foam may be disposed in the channels 26 to permit flow of the exhaust gases through the channels 26 while conducting thermal energy to the heat exchange baffles 25.

As illustrated in FIGS. 2A to 2C the reactive muffler heat-exchanger 15 preferably includes an inlet sub-chamber 27 arranged between the inlet 17 and the heat exchange baffles 25, i.e. the starts of the channels 26. The arrangement of the heat exchange baffles 25, together with the size and shape of the inlet sub-chamber 27, are configured to reflect sound waves in the exhaust gases back towards the inlet 17, in particular the end 21 of any inlet tube 19. In FIGS. 2A and 2C the inlet sub-chamber 27 is a flow reversal cavity as the direction of flow of the exhaust gases is reversed.

Preferably, the arrangement of the heat exchange baffles 25 and channels 26, together with the size and shape of the inlet sub-chamber 27, are configured such that the sound waves are reflected in such a way that they arrive at the inlet 17 in antiphase to the incoming sound waves. In particular, the change in cross-sectional area between the inlet sub-chamber 27 and each channel 26 will cause at least a partial reflection of acoustic waves in the exhaust gases back towards the inlet 17. The distance between the starts of the channels 26 and the inlet 17 (i.e. the size of the inlet sub-chamber 27) will then determine the phase of the reflected waves as they arrive back at the inlet 17. Accordingly, the size of the inlet sub-chamber 27 between the side 20 of the chamber 16 and the ends of the heat exchange baffles 25 is preferably one quarter of the wavelength of the targeted acoustic wave in the exhaust gases. In this way, destructive interference attenuates the incoming sound waves.

It will be appreciated that the wavelength of the acoustic wave will vary depending on operation of the internal combustion engine (in particular the timing of the outlet valves). In some examples, for example for a power generator, the internal combustion engine runs at a near constant speed and the wavelength of the acoustic wave in the exhaust gases will be approximately constant. In this example, the inlet sub-chamber 27 is preferably configured to generate destructive interference at this wavelength. In other examples, notably in automotive examples, the speed of the internal combustion engine will vary and so will the wavelength of the acoustic wave in the exhaust gases. In these examples, the inlet sub-chamber 27 is preferably configured to generate destructive interference for a key wavelength or range of wavelengths, for example a wavelength corresponding to a mid-range of the operating speed of the internal combustion engine, or at a wavelength of particular importance, for example longer wavelengths that may propagate further or create resonance in another part of the vehicle. Even if the wavelength varies, some destructive interreference is generated and this will impede acoustic waves.

Preferably, the muffler heat-exchanger illustrated in FIGS. 2A to 2C also includes an outlet sub-chamber 28 between the heat exchange baffles 25 and the outlet 18. The outlet sub-chamber 28 may be configured to generate destructive interference in the acoustic waves after the exhaust gases have passed the heat exchange baffles 25. In the examples, the side wall 23 of the chamber 16 on the side of outlet 18 reflects acoustic waves back towards the channels 26. In addition, the change of cross-sectional area between the outlet sub-chamber 28 and the outlet 18 (i.e. the outlet tube 22) would cause a partial reflection of acoustic waves back towards the channels 26. Therefore, the outlet sub-chamber 28 can be tuned to generate destructive interference in acoustic waves.

The example of FIG. 2C further includes an intermediate sub-chamber 39. The intermediate sub-chamber 39 is formed by providing heat exchange baffles 25a, 25b in two groups that define separate channels 26a, 26b. Exhaust gases flow from the inlet 17, through the first set of channels 26a formed by the first set of heat exchange baffles 25a, through the intermediate sub-chamber 39, through the second set of channels 26b formed by the second set of heat exchange baffles 25b, and to the outlet 18. The change of cross-sectional area from each of the first channels 26a into the intermediate sub-chamber 39, and from the intermediate sub-chamber 39 into the second channels 26b, causes partial reflections of acoustic waves. Therefore, the size of the intermediate sub-chamber 39 can be configured to generate destructive interference.

In the example of FIG. 2C, perforated plates (not illustrated) may extend from each of the first channels 26a to a corresponding second channel 26b, across the intermediate sub-chamber 39. The perforated plates may beneficially help to guide the flow of the exhaust gases from the first channels 26a to the second channels 26b without detrimentally increasing the back pressure that is generated as the cross-section area changes from the intermediate sub-chamber 39 to the second channels 26b. The perforations in the perforated plate permit acoustic waves to propagate through the intermediate sub-chamber 39, so that the intermediate sub-chamber 39 can generate destructive interference.

In some examples, a reactive muffler heat-exchanger 15 includes a plurality of chambers 16 arranged in series, each having one or more sub-chambers 27, 28, 39 configured to generate destructive interference of a different wavelength. In such examples, each of the chambers 16 may include heat exchange baffles 25 as shown in FIGS. 2A to 2C. In other such examples, only the first chamber may include heat exchange baffles as shown in FIGS. 2A to 2C, or only some of the chambers may include heat exchange baffles as shown in FIGS. 2A to 2C. Chambers without heat exchange baffles may include other features to reflect the sound waves, such as baffle plates (dividers with one or more holes). For the reasons described above, it is preferable to provide heat exchange baffles at the upstream end of the reactive muffler heat-exchanger. Therefore, in some preferred examples a first chamber 16 of the muffler heat-exchanger 15 includes heat exchange baffles 25 as shown in FIGS. 2A to 2C, and a subsequent chamber does not include heat exchange baffles. Both chambers comprise sub-chambers configured to generate destructive interreference of different wavelength acoustic waves.

In some examples, the heat exchange baffles 25 comprise conductive members, in particular fins, that extend from the chamber 16 to outside of the reactive muffler heat-exchanger 15 to conduct thermal energy to outside of the chamber 16. In some examples, a heat exchange fluid circuit may be arranged to circulate heat exchange fluid over the fins outside of the chamber 16 to absorb thermal energy and convey the thermal energy to the electrical power generator illustrated in FIG. 1. In other examples, the electrical power generator, for example a thermoelectric generator, may be in contact with the fins to generate electrical power from the thermal energy of the fins.

In preferred examples, the heat exchange baffles 25 comprise one or more heat exchange fluid channels that extend into the chamber 16. A heat exchange fluid circuit circulates heat exchange fluid through the heat exchange baffles 25 within the chamber 16 to receive thermal energy from the exhaust gases. The heat exchange fluid circuit then circulates the heat exchange fluid to the electrical power generator and back to the reactive muffler heat-exchanger 15.

In these examples, each heat exchange baffle 25 may comprise a hollow centre through which heat exchange fluid is circulated. Each heat exchange baffle 25 may be a hollow cuboid defining a heat exchange fluid channel through the hollow centre. Each heat exchange baffle 25 may include an inlet and an outlet for circulating heat exchange fluid through the heat exchange baffle 25.

Alternatively, each heat exchange baffle 25 may comprise a fluid channel, in particular a meandering fluid channel, through which heat exchange fluid is circulated. The fluid channels may be formed by a pipe or hose that extends through the heat exchange baffle 25 and is in contact with the heat exchange baffle 25, for example attached to a side of a hollow centre within the heat exchange baffle 25. In other examples, each heat exchange baffle 25 may comprise one or more integral fluid channel propagating, for example meandering, through the heat exchange baffle 25. The heat exchange baffles 25 are preferably made of a conductive material, for example a metal such as stainless steel.

The heat exchange fluid channels of the heat exchange baffles 25 may be connected in series or in parallel, or a combination of series and parallel.

In this way, heat exchange fluid is circulated through or past the heat exchange baffles 25 where it absorbs thermal energy from the exhaust gases. The heat exchange fluid is then conveyed to the electrical power generator as described above, and then re-circulated to the heat exchange baffles 25.

The reactive muffler heat-exchangers 15 of FIGS. 2A and 2B thereby act to extract thermal energy from the exhaust gases (via the heat exchange baffles 25) for generating electrical power, and also impede acoustic waves in the exhaust gases by configuring the inlet sub-chamber 27 (and optionally the outlet sub-chamber 28) for destructive interference.

FIG. 3 illustrates an example of the heat exchange baffles 25 of the reactive muffler heat-exchangers 15 of FIGS. 2A and 2B. As described previously, a plurality of heat exchange baffles 25 are preferably arranged parallel to each other and spaced within a chamber 16 to define channels 26 therebetween.

In the example of FIG. 3 the heat exchange baffle 25 comprises a planar cuboid section 29 that is disposed within the chamber (16, see FIGS. 2A and 2B) of the muffler heat-exchanger. The planar section 29 has opposing sides 30, 31 that form sides of channels (26, see FIGS. 2A and 2B). As mentioned above, the thickness of the heat exchange baffle 25, in particular the planar cuboid section 29 (i.e. between the opposing sides 30, 31) is preferably between about 3 millimetres and about 8 millimetres.

The heat exchange baffle 25 also includes an inlet 32 and an outlet 33 for heat exchange fluid. The inlet 32 and the outlet 33 extend to outside of the chamber (16, see FIGS. 2A and 2C. The planar cuboid section 29 is preferably hollow and heat exchange fluid is circulated through the heat exchange baffle 25 via the inlet 32 and the outlet 33. In other examples, the heat exchange baffle 25 comprises one or more fluid channels within the planar cuboid section 29 and the inlet 32 and the outlet 33 are in fluid communication with the fluid channels for passing heat exchange fluid through the heat exchange baffle 25. The fluid channels may be meandering tubes or pipes attached to a side of the hollow interior of the planar cuboid section 29, or may be integrally formed within the planar cuboid section 29. Preferably, the heat exchange baffle 25, in particular the planar cuboid section 29, is made of a conductive material such as stainless steel. As previously described, heat exchange fluid is circulated through the heat exchange baffle 25 to absorb thermal energy from the exhaust gases.

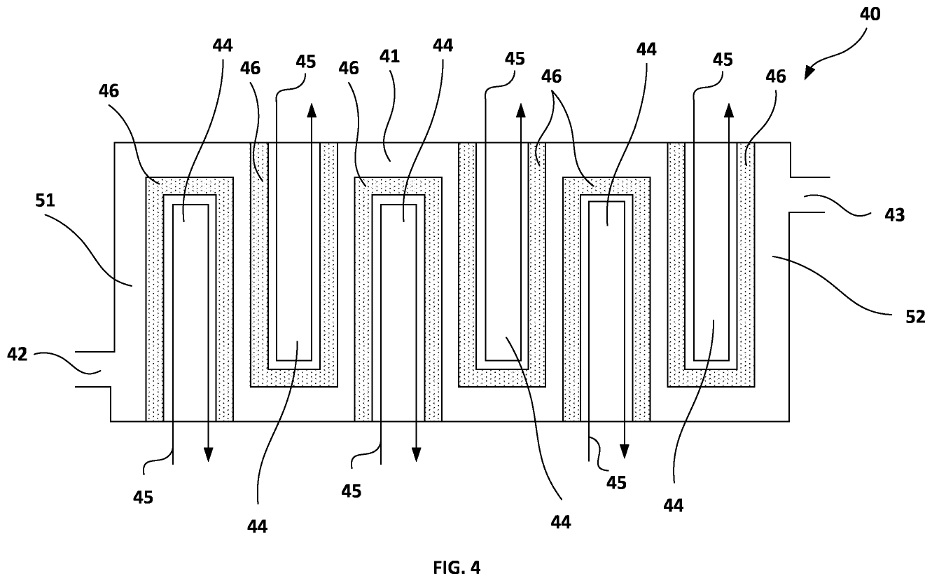

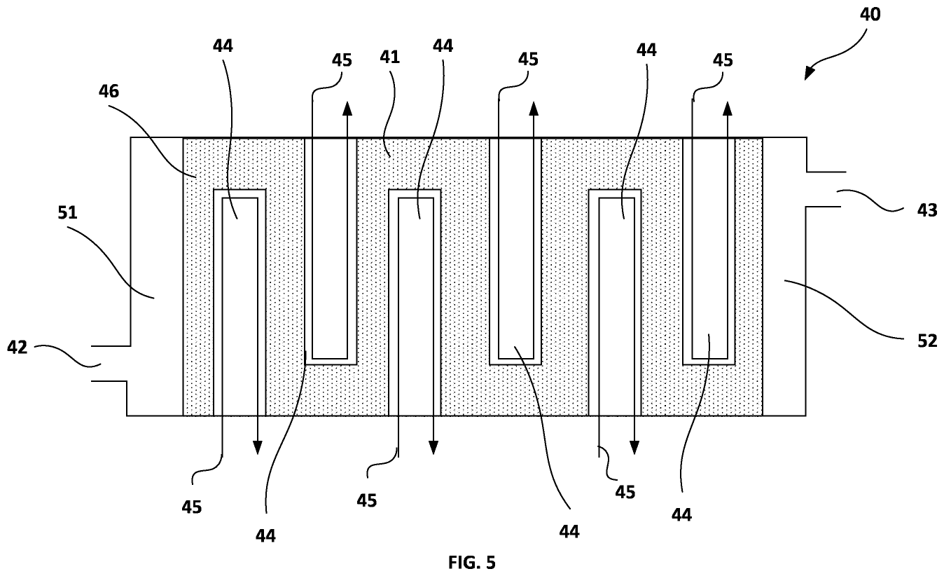

FIGS. 4 and 5 illustrate alternative examples of the muffler heat-exchanger 40. These example muffler heat-exchangers are lagged labyrinth muffler heat-exchangers 40.

In the examples of FIGS. 4 and 5 the lagged labyrinth muffler heat-exchangers 40 include a chamber 41 having an inlet 42 and an outlet 43 for the exhaust gases. Within the chamber 41 there are a series of heat-exchange baffles 44 arranged to define a meandering fluid path through the chamber 41 between the inlet 42 and the outlet 43. A heat exchange fluid is circulated within each heat exchange baffle 44.

In some examples, each heat exchange baffle 44 is hollow and has an inlet end and an outlet end. A heat exchange fluid is circulated through the heat exchange baffle 44. In other examples, heat exchange fluid channels 45, for example tubes, are arranged within each heat exchange baffle 44. Such heat exchange fluid channels 45 are schematically illustrated in FIG. 4. Heat exchange fluid is circulated between the heat exchange baffles 44 and the electrical power generator, as previously described.

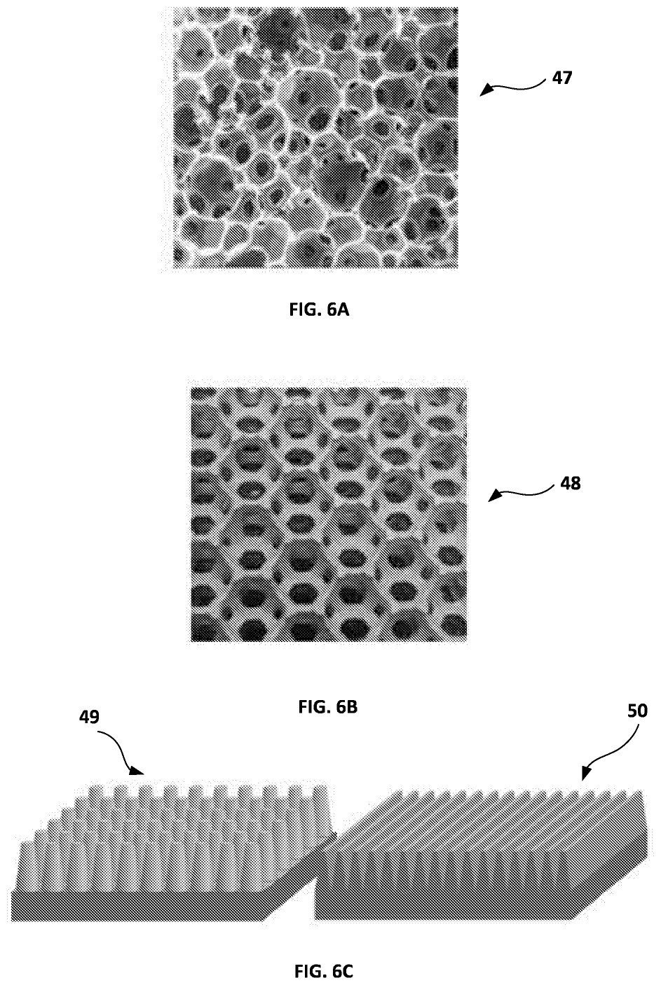

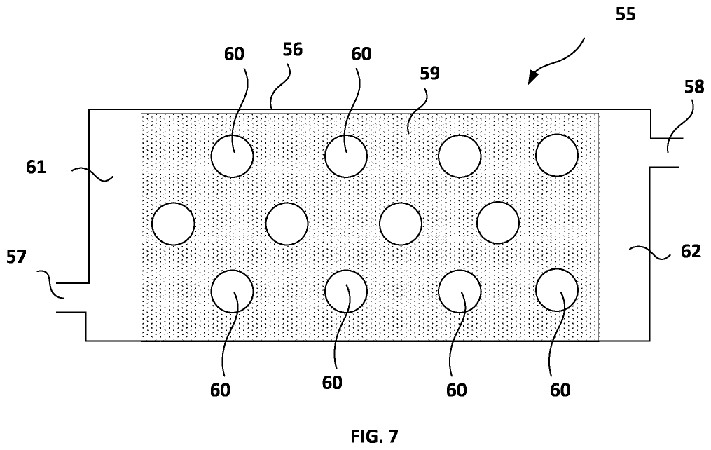

As illustrated in FIG. 4, each heat-exchange baffle 44 comprises a lagging material 46 arranged to cover at least a part (and preferably all of) the surface of the heat exchange baffle 44 within the chamber 41. The lagging material 46 preferably comprises a porous heat-conductive material. Preferably, the lagging material 46 comprises a porous matrix, for example a porous metal foam 47 as illustrated in FIG. 6A. An example porous metal foam is Dunlop Retimet®. Alternatively, the lagging material 46 may comprise a more uniform porous metal matrix 48, as illustrated in FIG. 6B. Such a porous metal matrix 48 may be manufactured using additive manufacturing. In other examples, the porous heat-conductive material comprises a structured matrix 49, 50 formed by moulding or additive manufacturing. Examples of different structured matrixes 49, 50 are shown in FIG. 6C. The porous heat-conductive material 46 acts to lag the exhaust gases, impeding acoustic waves, while increasing heat transfer from the exhaust gases to the heat exchange baffles 44.

The example of FIG. 5 is similar to the example of FIG. 4, except that the porous heat-conductive material 46 fills the fluid path between the heat exchange baffles 44 within the chamber 41. Specifically, the porous heat-conductive material 46 extends across the entire cross-section of the fluid path, between adjacent heat exchange baffles 44. Exhaust gases pass through the lagged labyrinth muffler heat-exchanger 40 by passing through the porous heat-conductive material 46, while acoustic waves are impeded and thermal energy is conducted to the heat exchange baffles 44.

As illustrated in FIG. 5, the chamber 41 may comprise an inlet sub-chamber 51 and optionally also an outlet sub-chamber 52. The inlet sub-chamber 51 and the outlet sub-chamber 52 are arranged between the porous heat-conductive material 46 and the inlet 42 and outlet 43, respectively.

As with previous examples, the inlet sub-chamber 51 may be configured (i.e. size and shape) to reflect sound waves passing through the inlet 42 back towards the inlet 42. The inlet sub-chamber 51 is preferably configured to reflect the sound waves back towards the inlet 42 in anti-phase so that destructive interference attenuates acoustic energy in the exhaust gases. The inlet sub-chamber 51 can be configured in the same manner as the inlet sub-chamber 27 described with reference to FIGS. 2A and 2B. Similarly, the outlet sub-chamber 52 may be configured to generate destructive interference in acoustic waves in the exhaust gases in the same manner as the outlet sub-chamber 28 described with reference to FIGS. 2A and 2B.

In a further example illustrated in FIG. 7, a lagged muffler heat-exchanger 55 comprises a chamber 56 having an inlet 57 and an outlet 58, and with porous heat-conductive material 59 filling the chamber 56 so that the exhaust gases flow through the porous heat-conductive material 59 between the inlet 57 and the outlet 58. The porous heat-conductive material 56 is preferably a porous metal foam 47 or a porous metal matrix 48 as shown in FIGS. 6A and 6B. One or more heat exchange fluid channels 60 extend through the porous heat-conductive material 59 and a heat exchange fluid is circulated through the heat exchange fluid channel(s) 60. In this way, heat exchange fluid in the heat exchange fluid channels 60 will absorb thermal energy from the exhaust gases while the porous heat-conductive material 59 impedes acoustic waves in the exhaust gases.

As per the examples of FIGS. 2A, 2B, 4, and 5, the lagged muffler heat-exchanger 55 of FIG. 7 may include an inlet sub-chamber 61 configured to generate destructive interference in acoustic waves. An outlet sub-chamber 62 may also be provided.

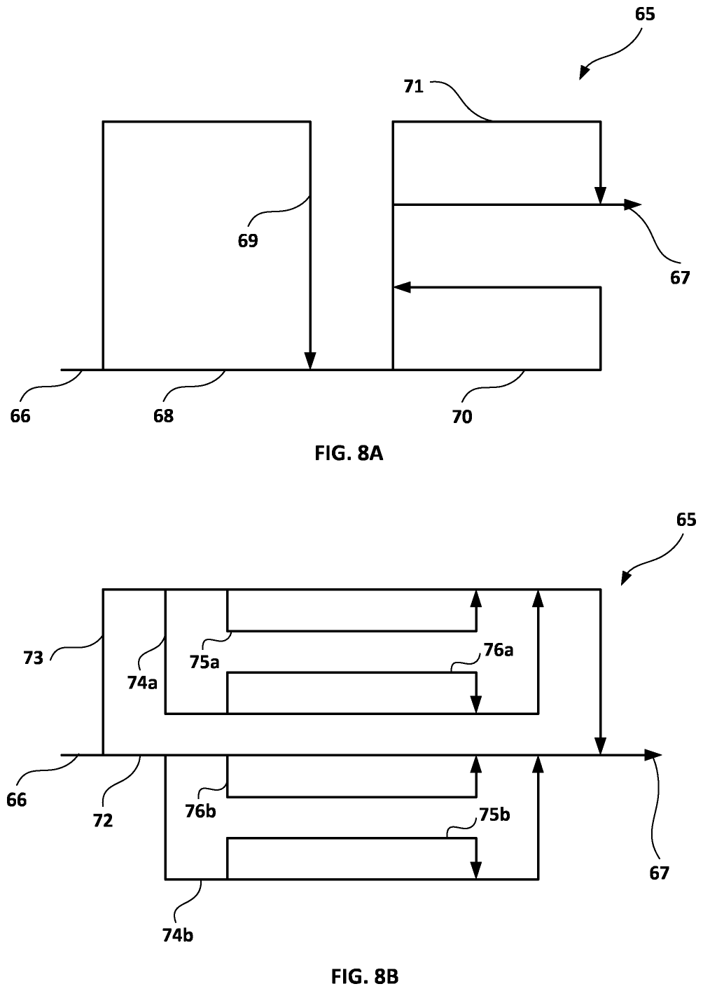

FIGS. 8A and 8B illustrate example interference muffler heat-exchangers 65. The interference muffler heat-exchanger 65 has an inlet 66, and outlet 67 a plurality of paths 68-76b that divide and merge between the inlet 66 and the outlet 67. Exhaust gases pass through the plurality of paths 68-76b. The plurality of paths 68-76b are configured so that where the different paths 68-76b merge the acoustic waves in the exhaust gases are at different wavelengths, and/or in different phases, and destructive interference acts to impede acoustic waves.

In the example of FIG. 8A the plurality of paths includes a first path 68 and second, third and fourth paths 69, 70, 71 that branch from the first path 68. The second, third and fourth paths 69, 70, 71 divide and merge with the first path 68 consecutively so that the paths 68-71 are connected in series between the inlet 66 and the outlet 67 and the exhaust gases flow through each path in turn. The second, third, and fourth paths 69, 70, 71 have different lengths so that as the second, third, and fourth paths 69, 70, 71 merge with the first path 68 acoustic waves in the exhaust gases are in different phase and cause destructive interference to impede acoustic waves in the exhaust gases.

In the example of FIG. 8B the plurality of paths includes a first path 72 extending between the inlet 66 and the outlet 67, and second, third, fourth, and fifth paths 73, 74, 75, 76 connected in parallel to the first path 72. In particular, the second path 73, divides and merges with the first path 72, the third path 74a divides and merges with the second path 73, the fourth path 75a divides and merges with the third path 74a, and the fifth path 76a divides and merges with the third path 74a. As illustrated, a second set of third, fourth, and fifth paths 74b, 75b, 76b may additionally be connected to the first path 72. The plurality of paths 73-76b have different lengths so that as the plurality of paths 73-76b merge with the first path 72 acoustic waves in the exhaust gases are in different phase and cause destructive interference to impede acoustic waves in the exhaust gases.

In the examples of FIGS. 8A and 8B at least one of the fluid paths 68-76b, preferably all of the fluid paths 68-76b, comprise a heat exchange fluid channel arranged to circulate heat exchange fluid to absorb thermal energy from the exhaust gases.

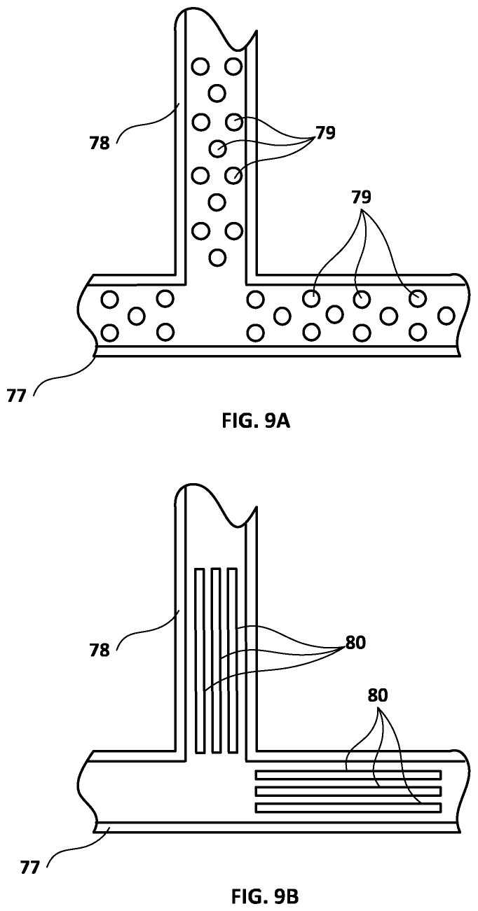

FIGS. 9A and 9B illustrate parts of the fluid paths 68-76b of the example interference muffler heat-exchangers 65 of FIGS. 8A and 8B. In particular, FIGS. 9A and 9B illustrate a branching or merging point of a first path 77 and a second path 78. The illustrated paths 77, 78 may be any of the plurality of fluid paths 68-76b illustrated in FIGS. 8A and 8B. The fluid paths 77, 78 are formed by conduits, in particular tubes. As illustrated, heat exchange fluid channels 79, 80 are arranged in the fluid paths 77, 78 and the exhaust gases pass over and around the heat exchange fluid channels 79, 80 during use so that thermal energy is transferred from the exhaust gases to the heat exchange fluid. The heat exchange fluid channels 79, 80 are part of a heat exchange fluid circuit that circulates the heat exchange fluid between the interference muffler heat-exchanger 65 and the electrical power generator, as previously described.

In the example of FIG. 9A heat exchange fluid channels 79 extend through the fluid paths 77, 78 so that the exhaust gases pass over and around the heat exchange fluid channels 79. The heat exchange fluid channels 79 comprise tubes that extend transverse to the direction of exhaust gas flow within the fluid path 77, 78. The heat exchange fluid channels 79 are connected in series or parallel, or a combination of series and parallel, and are connected to the heat exchange fluid circuit as previously described. The heat exchange fluid channels 79 are preferably made of a conductive material, for example a metal such as stainless steel. In some example, the heat exchange fluid channels 79 are at least partially covered with a porous heat-conducting material, such as the porous metal foam 47 or porous metal matrix 48 as shown in FIGS. 6A and 6B.

In the example of FIG. 9B the heat exchange fluid channels 80 are formed in baffles or tubes extending parallel to the direction of the exhaust gas flow within the fluid path 77, 78. The heat exchange fluid channels 80 are connected in series or parallel, or a combination of series and parallel. Each heat exchange fluid channel 80 has a conduit for heat exchange fluid. The heat exchange fluid channels 80 are preferably made of a conductive material, for example a metal such as stainless steel. In some example, the heat exchange fluid channels 80 are at least partially covered with a porous heat-conducting material, such as the porous metal foam 47 or porous metal matrix 48 as shown in FIGS. 6A and 6B.

As explained above, it is advantageous to lower the temperature of the exhaust gases, for example by a heat exchanger, before, or at least simultaneously, with the acoustic muffler.

Accordingly, in preferred examples the combined muffler heat-exchanger 15, 40, 55, 65 is configured such that thermal energy is extracted from the exhaust gases before, or simultaneously with, acoustic wave impedance. To achieve this, heat exchange components of the muffler heat-exchanger 15, 40, 55, 65 are arranged upstream of the muffler components, or at least in line with the beginning of the muffler components. In this way, the exhaust gases pass through the heat exchange components before, or simultaneously with, the muffler components.

In the various examples of FIGS. 2A and 2B the heat exchange components comprise the heat exchange baffles 25, in particular the heat exchange fluid channels within the heat exchange baffles 25. In the examples of FIGS. 4 and 5 the heat exchange components comprise the heat exchange fluid channels 45 within the heat exchange baffles 44. In the examples of FIG. 7 the heat exchange components comprise the heat exchange fluid channels 60. In the examples of FIGS. 8A to 9B the heat exchange components comprise the heat exchange fluid channels 79, 80. As described, the heat exchange components are part of a heat exchange fluid circuit that circulates heat exchange fluid between the heat exchange components and the electrical power generator. In the various examples the muffler components comprise the components that impede acoustic waves in the exhaust gases. This includes the various chambers and sub-chambers 27, 28, 51, 52, 61, 62 configured to generate destructive interference in the acoustic waves, any lagging materials, such as porous matrix materials 46, 59, and the branched fluid paths 68-76b of the interference muffler 65.

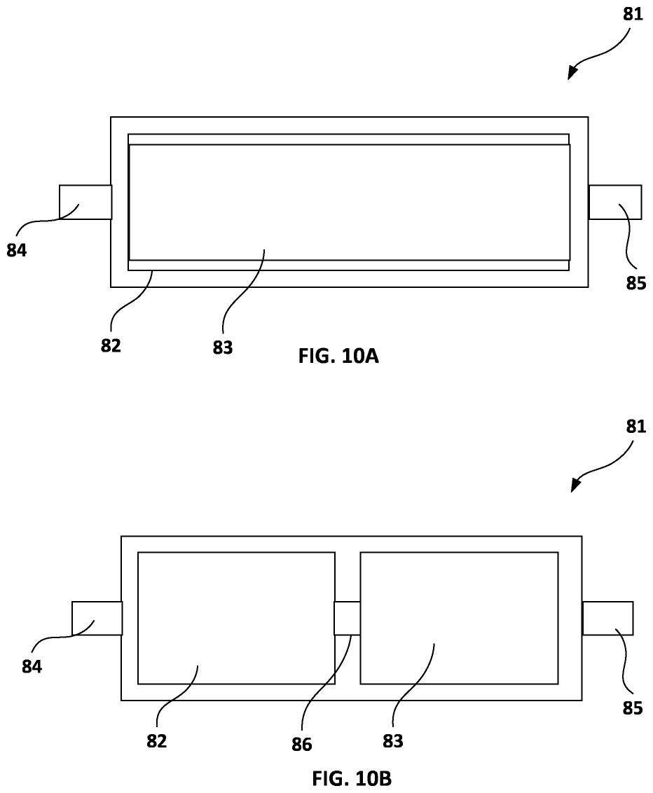

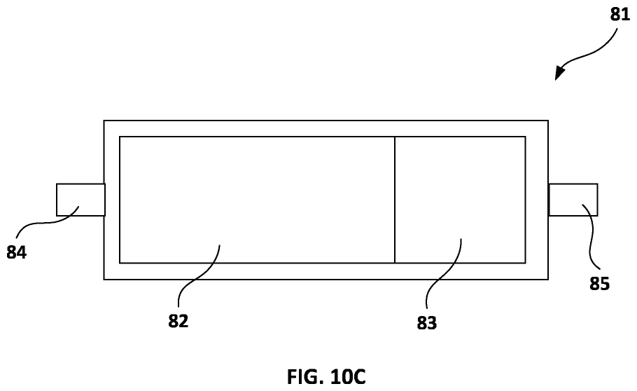

FIGS. 10A to 10C schematically illustrate different example arrangements of the heat exchange components 82 and the muffler components 83 within a combined muffler heat-exchanger 81. Each example muffler heat-exchanger 81 has an inlet 84 and an outlet 85.

In some examples, illustrated schematically in FIG. 10A, the heat exchange components 82 are contiguous with the muffler components 83. In particular, the heat exchange components 82 extend over the same parts of the combined muffler heat-exchanger 81 as the muffler components 83. Such examples are illustrated in FIGS. 2A to 9B as the heat exchange components 82 are disposed in the same parts of the combined muffler heat-exchanger 81 as the muffler components 83. In these examples the temperature of the exhaust gases is reduced at the same time as the muffler components 83 start to impede acoustic waves.

FIG. 10B illustrates a further example combined muffler heat-exchanger 81. In this example the muffler components 83 are separate to the heat exchanger components 82. The muffler components 83 are arranged downstream of the heat exchanger components 82.

As illustrated in FIG. 10B, the heat exchange components 82 are connected to the muffler components 83 by a connecting tube 86. Exhaust gases flow first through the heat exchanger components 82, then through the connecting tube 86, and then through the muffler components 83. The connecting tube 86 may be configured as a part of a reactive muffler.

With reference to FIG. 10B, in other examples, a combined muffler heat-exchanger 82 is provided upstream, and a muffler 83 is provided downstream. The combined muffler heat-exchanger 82 may be any of the examples of FIGS. 2A to 9B, and the muffler 83 may be a lagged muffler, a lagged labyrinth muffler, an unlagged labyrinth muffler, a reactive muffler, or an interference muffler. In these examples the combined muffler heat-exchanger 82 reduces the temperature of the exhaust gases and simultaneously impedes acoustic waves, and subsequently the muffler 83 acts to further impede acoustic waves. The muffler components of the combined muffler heat-exchanger 82 and the muffler 83 may be configured to impede different wavelength acoustic waves. Advantageously, as the exhaust gases are cooler and denser on reaching the muffler 83 so that the muffler 83 can be smaller and more compact.

FIG. 10C illustrates a similar example combined muffler heat-exchanger 81 to FIG. 10B, with heat exchange components 82 and muffler components 83 arranged in series. In this example, there is no connecting tube and the exhaust gases flow directly from the heat exchange components 82 to the muffler components 83.

In an alternative example of FIG. 10C the combined muffler heat-exchanger 81 is formed of one combined muffler heat-exchanger, where the muffler components 83 extend along the length of the combined muffler heat-exchanger and the heat exchange components 82 extend only partially along the length of the combined muffler heat-exchanger 81.

For example, referring to FIGS. 4 and 5, only the upstream heat exchange baffles 25, for example the first one to five heat exchange baffles 25, include heat exchange fluid channels, and the downstream heat exchange baffles 25, for example the last one to five heat exchange baffles 25, do not include heat exchange fluid channels. Similarly, referring to FIG. 7, the heat exchange fluid channels 60 may only be located in at an upstream end of the chamber 56. In the examples of FIGS. 8A and 8B, only upstream portions of the fluid paths 68-76b may include heat exchange components, in particular the heat exchange channels 79, 80 as illustrated in FIGS. 9A and 9B. In these examples the heat exchange components 82 extract thermal energy from the exhaust gases simultaneously with the muffler components 83 impeding acoustic waves, and the downstream muffler components 83 then acts to further impede acoustic waves.

Throughout the description and claims of this specification, the words “comprise” and “contain” and variations of them mean “including but not limited to”, and they are not intended to (and do not) exclude other components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

1. A muffler heat-exchanger for an engine exhaust, the muffler heat-exchanger comprising:
a chamber having an inlet and an outlet arranged such that during use exhaust gases flow through from the inlet to the outlet through the chamber, and
at least one heat exchange baffle disposed in the chamber to recover heat energy from the exhaust gases during use,
wherein the at least one heat exchange baffle is configured to reflect acoustic waves in the exhaust gases towards the inlet to generate destructive interference and impede incoming acoustic waves at the inlet.

2. The muffler heat-exchanger of claim 1, wherein the at least one heat exchange baffle is elongate and an end of the elongate heat exchange baffle is directed towards the inlet to reflect acoustic waves in the exhaust gases.

3. The muffler heat-exchanger of claim 2, wherein the end of the at least one heat exchange baffle is spaced from the inlet by a distance of about quarter of a wavelength of an acoustic wave in the exhaust gases.

4. The muffler heat-exchanger of claim 2, wherein the chamber comprises an inlet sub-chamber disposed between the inlet and the end of the at least one heat exchange baffle, and wherein the inlet sub-chamber is configured to act as a resonance chamber for acoustic waves of the exhaust gases.

5. The muffler heat-exchanger of claim 1, wherein the muffler-heat exchanger comprises a plurality of heat exchange baffles.

6. The muffler heat-exchanger of claim 5, wherein the plurality of heat exchange baffles are arranged parallel to each other and spaced apart to define channels between adjacent heat exchange baffles.

7. The muffler heat-exchanger of claim 5, wherein adjacent heat exchange baffles are spaced apart by between about 3 millimetres and about 8 millimetres.

8. The muffler heat-exchanger of claim 1, wherein the at least one heat exchange baffle comprises a heat exchange fluid channel for a heat exchange fluid.

9. The muffler heat-exchanger of claim 8, wherein the at least one heat exchange fluid channel is connected to a heat exchange fluid circuit arranged to circulate the heat exchange fluid to an electrical power generator.

10. The muffler heat-exchanger of claim 8, wherein the at least one heat exchange baffle comprises a planar section defining a side of at least one channel, wherein the planar section comprises is hollow defining a cavity therein, and wherein the heat exchange fluid channel comprises the cavity.

11. The muffler heat-exchanger of claim 1, further comprising a second muffler configured to impede acoustic waves in the exhaust gases, and wherein the second muffler is arranged downstream of the at least one heat exchange baffle.

12. The muffler heat-exchanger of claim 11, wherein the second muffler is arranged either at a downstream end of the chamber, or downstream of the outlet.

13. An exhaust system comprising the muffler heat-exchanger of claim 1.

14. An engine system comprising an internal combustion engine, the exhaust system of claim 13 arranged to receive exhaust gases from the internal combustion engine, and an electrical power generator configured to generate electrical power from the thermal energy recovered by the muffler heat-exchanger.

15. The engine system of claim 14, further comprising a heat exchange fluid circuit configured to circulate a heat exchange fluid between the muffler heat-exchanger and the electrical power generator.

16. The engine system of claim 14, wherein the internal combustion engine comprises an air inlet, and wherein the engine system further comprises an electrically-driven compressor arranged to compress air for the air inlet.

17. The engine system of claim 16, further comprising a power management system arranged to manage electrical power generated by the electrical power generator, and to supply electrical power to the electrically-driven compressor.

18. An exhaust system for an internal combustion engine, the exhaust system comprising a heat exchange portion and a muffler portion arranged such that exhaust gases flow through the heat exchange portion and the muffler portion during use, wherein the heat exchange portion is configured to extract thermal energy from the exhaust gases, wherein the muffler portion is configured to impede acoustic waves in the exhaust gases, and wherein the heat exchange portion is:
arranged upstream of the muffler portion, or
aligned with at least an upstream end of the muffler portion.

19. The exhaust system of claim 18, wherein the heat exchange portion and the muffler portion are separate and the heat exchange portion is arranged upstream of the muffler portion.

20. The exhaust system of claim 18, wherein the heat exchange portion and the muffler portion are combined in a combined muffler heat-exchanger.

21. The exhaust system of claim 20, wherein the heat exchange portion and the muffler portion overlap, and wherein the heat exchange portion is aligned with at least an upstream end of the muffler portion.
